(19) United States
(12) Patent Application Publication
(10) Pub. No.: US 2008/0297655 A1
(43) Pub. Date: Dec. 4, 2008

(54) TELEVISION RECEIVING APPARATUS AND DEVICE CONTROL METHOD

(75) Inventor: Masahiro KAMIDA, Saitama-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/052,870

(22) Filed: Mar. 21, 2008

(30) Foreign Application Priority Data
May 31, 2007 (JP) 2007145643

(51) Int. Cl. H04N 11/00

(52) U.S. Cl. 348/552; 348/E11.002; 348/E17.003

(57) ABSTRACT

A television receiving apparatus has: a storage unit storing identification information, which identifies devices outputting image signals; a display control unit displaying a device selection screen for selecting a device to output an image signal based on the stored identification information; a confirmation unit confirming whether the device is in an active state or a standby state; and a transmitter transmitting a command, which instructs the selected device to output the image signal, when it is confirmed that the selected device is in an active state.

### CROSS REFERENCE TO RELATED APPLICATIONS

This application is based upon and claims the benefit of priority from the prior Japanese Patent Application Ser. No. 2007-145643, filed on May 31, 2007; the entire contents of which are incorporated herein by reference.

### BACKGROUND OF THE INVENTION

1. Field of the Invention

The present invention relates to a television receiving apparatus and a device control method.

2. Description of the Related Art

Techniques of a television broadcast receiving apparatus for receiving and displaying television broadcasts have been disclosed (for example, see JP-A 2004-221732 (KOKAI)). Here, various devices are often connected to the television broadcast receiving apparatus and, for example, the HDMI (High-Definition Multimedia Interface) standard is employed in those connections. Using signal protocols of the HDMI-CEC (Consumer Electronics Control) standard, devices applicable to the HDMI standard are able to communicate with or control each other.

### BRIEF SUMMARY OF THE INVENTION

However, such a communication standard is not always able to control devices corresponding to the state of the devices. For example, according to the HDMI-CEC standard, when a device in a standby state receives a switching command to switch devices, activation of the device is recommended. In this case, when the devices are switched in order, the devices, which are not finally selected by the user (all devices which are switched), are made shifted to an active state. This requires the user, for example, to shift back the devices, which are not finally selected, to a standby state.

In view of the above problem, the present invention has an object to provide a television receiving apparatus and a device control method, for controlling devices corresponding to the state of devices.

A television receiving apparatus according to an aspect of the present invention has: a storage unit storing identification information, which identifies devices outputting image signals; a display control unit displaying a device selection screen for selecting a device to output an image signal based on the stored identification information; a confirmation unit confirming whether the device is in an active state or a standby state; and a transmitter transmitting a command, which instructs the selected device to output the image signal, when it is confirmed that the selected device selected is in an active state.

A device control method according to another aspect of the present invention has: displaying a device selection screen for selecting a device to output an image signal based on a storage content of a storage unit storing identification information, which identifies devices outputting image signals; confirming whether the device is in an active state or a standby state; and transmitting a command, which instructs the selected device to output the image signal when the selected device is in an active state.

### BRIEF DESCRIPTION OF THE DRAWINGS

FIG. 1 is a block diagram showing a television receiving system 100 according to an embodiment of the present invention.

FIG. 2 is a schematic diagram showing storage content of a device connection information storage unit.

FIG. 3 is a flow diagram showing an operating procedure of the television receiving system.

FIG. 4 is a diagram showing a screen used to input setting information indicating whether to activate when switching.

FIG. 5 is a diagram showing a device selection screen.

FIG. 6 is a diagram showing an activation selection screen.

### DETAILED DESCRIPTION OF THE INVENTION

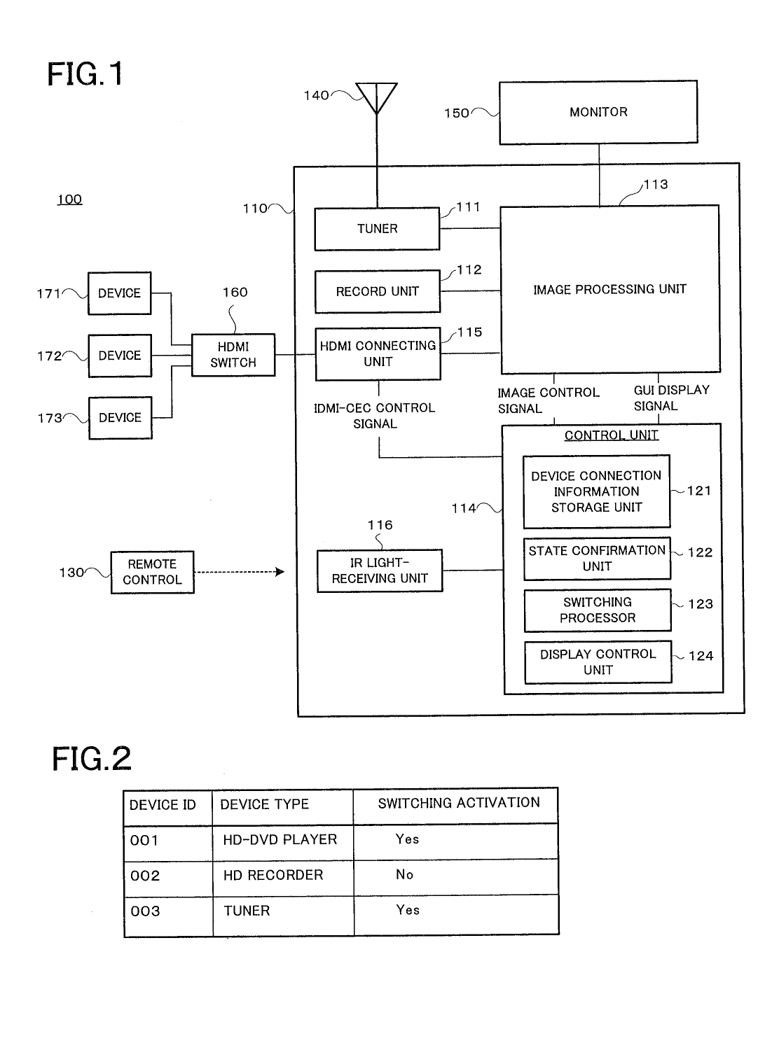

Embodiments of the present invention will be described in detail with reference to the drawings. FIG. 1 is a block diagram showing a television receiving system 100 according to an embodiment of the present invention. The television receiving system 100 includes a television receiving apparatus 110, a remote control 130, an antenna 140, a monitor 150, an HDMI switch 160, and devices 171-173.

The television receiving apparatus 110 is an apparatus for receiving television images to display on the monitor 150 and includes a tuner 111, a record unit 112, an image processing unit 113, a control unit 114, an HDMI connecting unit 115, and an IR light-receiving unit 116.

The tuner 111 selects (selects a channel of) an appropriate television broadcast program (for example, digital broadcast) from radio waves received via the antenna 140.

The record unit 112 records the television broadcast selected by the tuner 111.

The image processing unit 113 mediates among the tuner 111, record unit 112 and devices 171-173 for inputting and outputting image signals and converts the image signals output from the tuner 111, record unit 112 and devices 171-173 into signals applicable to be displayed on the monitor 150 (signal processing).

The control unit 114 is a control unit for controlling the television receiving apparatus 110 and composed of a combination of a CPU (Central Processing Unit) and a memory (for example, a semiconductor memory). The control unit 114 outputs image control signals and GUI display signals to the image processing unit 113. The image control signal is a signal to control a processing of television broadcast signals in the image processing unit 113. The GUI display signal is a signal to display an image (GUI image), which is used by a user to input information, on the monitor 150.

The control unit 114 is connected to the HDMI connecting unit 115 via a CEC control line and outputs HDMI-CEC control signals (commands) to control the HDMI switch 160 and devices 171-173 or to confirm states of the HDMI switch 160 and devices 171-173. The control unit 114 accepts user's input information from the IR light-receiving unit 116.

The control unit 114 includes a device connection information storage unit 121, a state confirmation unit 122, a switching processor 123 and a display control unit 124.

The device connection information storage unit 121 stores information of the devices 171-173 connected to the television receiving apparatus 110. FIG. 2 is a schematic diagram showing storage content of the device connection information storage unit 121.

The content shows information of “Device ID (Identifier)”, “Device Types” and“Switching Activation”, which are associated with each other. In the “Device ID”, identification information identifying the devices 171-173, such as addresses of the devices 171-173, is inserted. In the “Device Type”, information indicating types of the devices 171-173, such as a player, a recorder or a tuner, is inserted. In the “Switching Activation”, switching activation information, which indicates whether to activate (apply power to) the devices 171-173 in a standby state when switching the devices 171-173 for inputting image signals, is inserted.

The “Device ID” and “Device Type” are stored in the device connection information storage unit 121 as results of connecting process when the devices 171-173 are connected to the HDMI switch 160. Further, the “Switching Activation” is stored in the device connection information storage unit 121 as results of a later described setting inputs to the devices. In other words, FIG. 2 shows storage content of the device connection information storage unit 121 after settings are input to the devices. Before settings are input to the devices, “Switching Activation” shows “-” which means that the device is not set yet.

The HDMI switch 160 is a broadly specified device and its ID and the like are stored in the device connection information storage unit 121 although it is not shown in FIG. 2.

The state confirmation unit 122 confirms whether the connected device 171-173 is in an active state or a standby state. In other words, the state confirmation unit 122 transmits a command to instruct the device 171-173 to notify its state (power state) and receives a response command (a command notifying its power state) from the device 171-173. Through this procedure, the state confirmation unit 122 confirms the state of the device 171-173.

The switching processor 123 switches image signal inputs from the devices 171-173. The switching processor 123 transmits a switching command to execute the switching. That is, the switching processor 123 serves as a transmitter for transmitting commands. The switching command provides the following instructions (1) to (3).

(1) Instructing the HDMI switch 160 to switch the input source of image signals. Here, the switching command indicates which of the devices 171-173 is to be selected as a new input source. Upon receiving the switching command, the HDMI switch 160 switches the connecting relation between device terminals and an apparatus terminal so that the image signal from the specified input source is output to the television receiving apparatus 110.

(2) Instructing the device 171-173 selected as the input source to output an image signal. In response to this instruction, the selected device 171-173 outputs an image signal.

(3) Instructing the device 171-173 selected as the input source to activate itself when it is in a standby state. In response to this instruction, the selected device 171-173 activates itself when it is in a standby state. Prior to a transmission of this switching command, the state confirmation unit 122 confirms the state of the device 171-173, as described below.

The display control unit 124 controls the monitor 150 to display a device selection screen and an activation selection screen. The device selection screen is a GUI screen used to select a device 171-173 as an input source of image signals. The activation selection screen is a GUI screen used to select (set the switching activation information) whether to activate the device 171-173 in a standby state when switching (need for an activation).

The HDMI connecting unit 115 is an interface for connecting to a device, which is applicable to the HDMI standard. The HDMI switch 160 and devices 171-173 are directly or indirectly connected, as being applicable to the HDMI standard. The HDMI connecting unit 115 mediates among the devices 171-173 and image processing unit 113 for inputting and outputting image signals. Further, the HDMI connecting unit 115 mediates among the HDMI switch 160, devices 171-173 and control unit 114 for inputting and outputting commands.

The IR light-receiving unit 116 receives an infrared (IR) light emission from the remote control 130 based on a user's operation, converts it into signals, and outputs the signals to the control unit 114.

The remote control 130 is a remote control device, which emits infrared light according to the user's operation and controls the television receiving apparatus 110.

The antenna 140 is to receive radio wave including television broadcast.

The monitor 150 is a display device for displaying television broadcast, such as a liquid crystal display device and a plasma display.

The HDMI switch 160 includes the plurality of device terminals and the single apparatus terminal, switches and connects the device terminals with respect to the apparatus terminal. The devices 171-173 and the HDMI connecting unit 115 (television receiving apparatus 110) are connected to the device terminals and the apparatus terminal, respectively. According to a switching command from the control unit 114, the HDMI switch 160 selects plural devices 171-173 and connects them to the HDMI connecting unit 115. With this structure, the input sources of image signals with respect to the television receiving apparatus 110 can be switched. The HDMI switch 160 includes a storage unit storing a table showing a correspondence relation between IDs of the devices 171-173 and the device terminals in order to execute the switching.

Here, in this example, the three devices 171-173 are connected to the HDMI switch 160; however, the number of the devices can arbitrary be modified.

The devices 171-173 are devices for inputting or outputting image signals, such as an HD-DVD player, HD (hard disk) recorder and a tuner. Activations, image outputs and the like of the devices 171-173 are controlled by commands from the control unit 114.

These devices 171-173 are two operation states: an ON state (active state) and an OFF state (standby state). For example, the device is in an OFF state when the device 171-173 is plugged to a power source, and thereafter, the device is shifted in an ON state when a power switch is pressed.

These two states correspond to the power state, that is, the power consumption in the device 171-173. In an ON state (active state), power is consumed in the entire of the device 171-173 and its primary function (for example, are producing function, a recording function, etc.) can be obtained. On the other hand, in an OFF state (standby state), power is consumed only in a part of the device 171-173, such as an HDMI interface, and power is not supplied to a primary part of the device. Thus, the device 171-173 in a standby state cannot perform its primary function (for example, a reproducing function, a recording function, etc.). However, even when the device 171-173 is in a standby state, activation and state confirmation of the device 171-173 can be executed in response to an HDMI-CEC command.

### (Operation of the Television Receiving System 100)

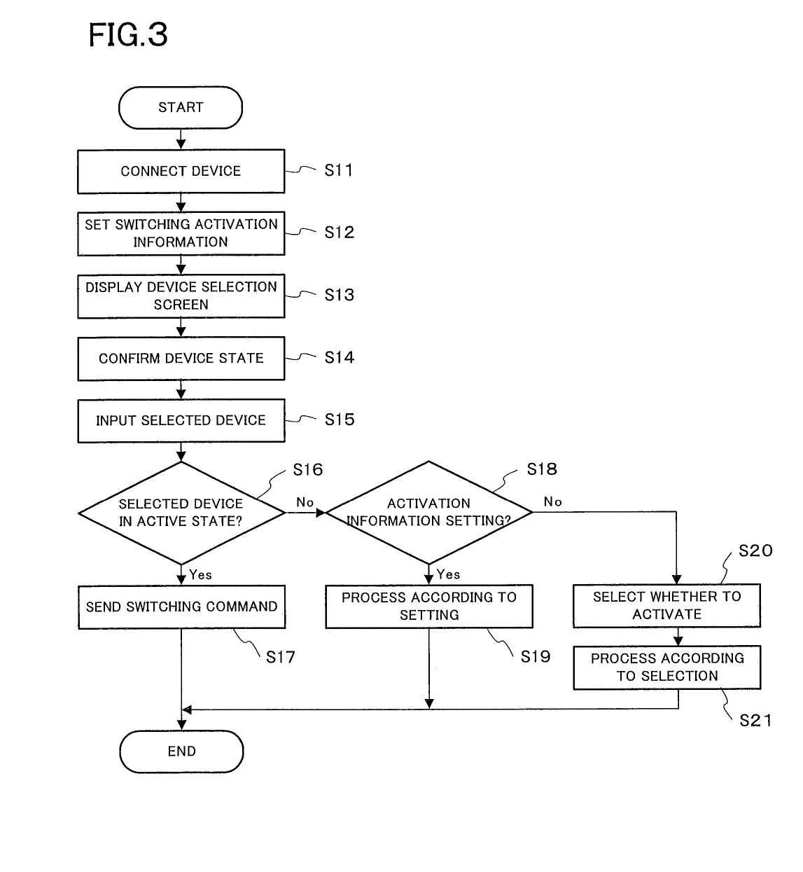

FIG. 3 is a flow diagram showing an operating procedure of the television receiving system 100.

### (1) Connecting the Devices (Step S11)

It is assumed that, initially, the device 171-173 is not connected to the HDMI switch 160. When the device 171-173 is connected to the HDMI switch 160, the control unit 114 recognizes the existence of the device 171-173 according to the connection. In other words, commands are sent between the control unit 114 and the device 171-173 and, during this communication, an ID and a device type of the device 171-173 are notified to the control unit 114 and stored in the connection information storage unit 121. The “switching activation” is not set at this timing.

### (2) Setting of the Switching Activation Information (Step S12)

A user operates the remote control 130 and sets (inputs) switching activation information (information indicating whether to activate the device 171-173 in a standby state when switching) of the device 171-173.

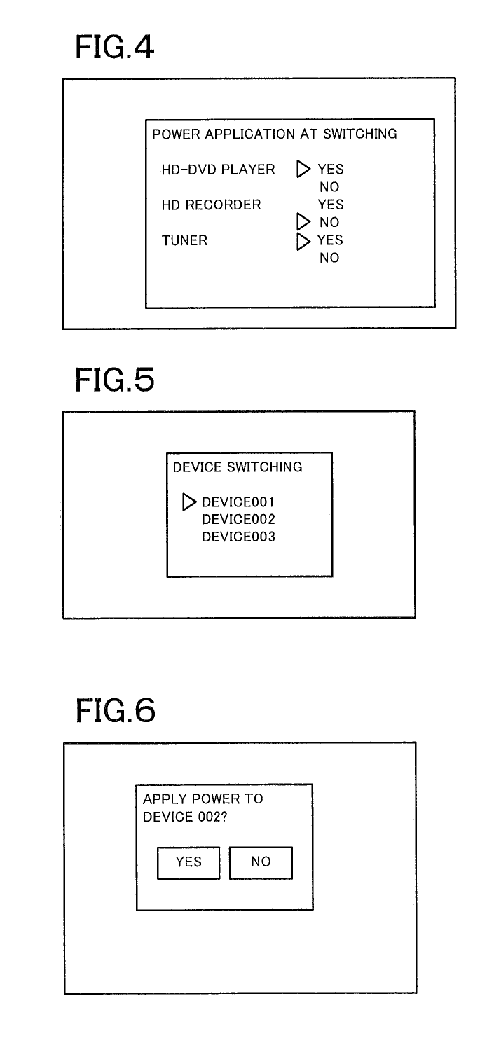

FIG. 4 is a diagram showing an example of a GUI screen (activation selection screen) used to input switching activation information. When each of the devices 171-173 is set whether to supply power to (activate) itself when switching, “Yes” or “No” is inserted in the “switching activation” in the connection information storage unit 121 (see FIG. 2).

### (3) Selecting a Device as an Input Source (Steps S13-S15)

a. Displaying the Device Selection Screen (Step S13)

When the user operates the remote control 130, the device selection screen is displayed. FIG. 5 is a diagram showing an example of the device selection screen. The device selection screen is a GUI screen used to input information indicating devices to be selected as an input source of image signals.

b. Confirming the Device State (Step S14)

The state of the device 171-173 is confirmed. In other words, the control unit 114 transmits a command, which instructs the device 171-173 to notify its state (an active state or a standby state). In response to this command, the device 171-173 transmits a command, which notifies the state to the control unit 114, so that the state of the device 171-173 is notified to the control unit 114.

This confirmation can be executed at different timings before a transmission of a switching command. For example, the state of the device 171-173 can be confirmed (step S14) before the device selection screen is displayed (step 13).

c. Inputting the Selected Device (Step S15)

When the user operates the remote control 130, one of the devices 171-173 is selected from a list of the devices 171-173 shown on the device selection screen.

### (4) Transmitting a Switching Command to the Device (Steps S16-S21)

Corresponding to the state and the like of the device 171-173, a switching command is transmitted.

a. Case of a Selected Device 171-173 in an Active State (Steps S16, S17)

When the device 171-173 in an active state is selected (step S16), a switching command is transmitted to the selected device 171-173 (step S17). The switch 160 operates and the input source of image signals is switched to the selected device 171-173. Further, the selected device 171-173 outputs an image signal. The image from the selected device 171-173 is then displayed on the monitor 150.

Since the selected device 171-173 is in an active state, it is prevented that other devices 171-173 in a standby state are unnecessarily activated. When the selected device 171-173 is in a standby state, it is confirmed whether or not the switching activation is set in advance in step S18.

b. Case of a Selected Device 171-173 in a Standby State, with a Setting of Switching Activation Information (Steps S18, S19)

In this case, a process corresponding to the switching activation setting is executed (step S19). In other words, a switching command is transmitted to a device 171-173 having a setting of “Yes” (applying power). With this procedure, the switch 160 is switched, the selected device 171-173 is activated, and an image signal is output. On the other hand, when a device 171-173 having a setting of “No” (not applying power) is selected, a switching command is not transmitted and the image displayed on the monitor 150 is not switched.

c. Case of a Selected Device 171-173 in a Standby State, Without a Setting of Switching Activation Information (Steps S20, S21)

In this case, the user selects whether to apply power to the device 171-173 and a switching command is transmitted corresponding to the selection.

The activation selection screen (switching permission screen) is displayed on the monitor 150. FIG. 6 is a diagram showing an example of the activation selection screen. The activation selection screen is a GUI screen used to input information indicating whether to activate (apply or not apply power to) the device 171-173 (a GUI screen to ask permission for applying power to the device 171-173). When the user selects “Yes”, the device 171-173 is activated and the image from the device 171-173 is displayed on the monitor 150. When the user selects “No”, a switching command is not sent and switching process is not executed.

As described above, in the television receiving system 100, a state (power state) of the device 171-173 connected to the television receiving apparatus 110 is confirmed so that it can be prevented that power is applied to the devices 171-173 regardless of its necessity when switching the devices 171-173. This results in a reduction of power consumption and a prevention of power application against users'will.

### Other Embodiments

Embodiments of the present invention are not limited to the above-described embodiments, but the above-described embodiments can be expanded and modified, and the expanded and modified embodiments are also included in the technical range of the present invention.

What is claimed is:

1. A television receiving apparatus, comprising:
a storage unit storing identification information, which identifying devices outputting image signals;
a first display control unit displaying a device selection screen for selecting a device to output an image signal based on the stored identification information;
a confirmation unit confirming whether the selected device is in an active state or a standby state; and
a first transmitter transmitting a command, which instructs the selected device to output the image signal, when it is confirmed that the device selected is in an active state.

2. The television receiving apparatus as set forth in claim 1,
wherein the command instructs a device in a standby state to activate the device itself to output the image signal.

3. The television receiving apparatus as set forth in claim 1,
wherein the device is connected to a switch switching an input source of the image signal; and
wherein the command instructs the switch to switch the input source.

4. The television receiving apparatus as set forth in claim 1, further comprising:
a second display control unit displaying an activation selection screen for selecting whether to activate the selected device when it is confirmed that the selected device is in a standby state; and
a second transmitter transmitting the command to the device, which is selected to be activated.

5. The television receiving apparatus as set forth in claim 1,
wherein the storage unit further stores activation information which indicates whether to activate the device when the device indicated by the identification information is in a standby state; and
wherein the television receiving apparatus, further comprising a determination unit determining whether to transmit the command based on the stored activation information.

6. The television receiving apparatus as set forth in claim 1, further comprising a tuner selecting a broadcast program.

7. A device control method, comprising:
displaying a device selection screen for selecting a device to output an image signal based on a storage content of a storage unit storing identification information, which identifies devices outputting image signals;
confirming whether the device is in an active state or a standby state; and
transmitting a command, which instructs the selected device to output the image signal when the selected device is in an active state.

8. The device control method as set forth in claim 7,
wherein the command instructs a device in a standby state to activate itself to output the image signal.

9. The device control method as set forth in claim 7,
wherein the device is connected to a switch switching an input source of the image signal; and
wherein the command instructs the switch to switch the input source.

10. The device control method as set forth in claim 7, further comprising:
displaying an activation selection screen for selecting whether to activate the selected device when it is confirmed that the selected device is in a standby state; and
transmitting the command to the device, which is selected to be activated.

11. The device control method as set forth in claim 7,
wherein the storage unit further stores activation information indicating whether to activate the device when the device indicated by the identification information is in a standby state, and
wherein the device control method, further comprising determining whether to send the command based on the stored activation information.
